(19) United States
(12) Patent Application Publication
(10) Pub. No.: US 2024/0269546 A1
(43) Pub. Date: Aug. 15, 2024

(54) SYSTEM AND METHOD OF ENHANCED USER INTERACTION PLATFORM

(71) Applicant: BETS FLOW LTD., Tel Aviv (IL)

(72) Inventor: Tal HAYON, Tel Aviv (IL)

(73) Assignee: BETS FLOW LTD., Tel Aviv (IL)

(21) Appl. No.: 18/565,683

(22) PCT Filed: Jun. 1, 2022
(86) PCT No.: PCT/IL2022/050582

§ 371 Date: Nov. 30, 2023

Related U.S. Application Data
(60) Provisional application No. 63/195,196, filed on Jun. 1, 2021.

(51) Int. Cl. A63F 13/213; A63F 13/35; A63F 13/65

(52) U.S. Cl. CPC A63F 13/213; A63F 13/35; A63F 13/65; A63F 2300/8082

(57) ABSTRACT

Systems and methods for emulated user interaction system, including a user's computing device, an operator's computing device, coupled to at least one sensor, and a server, in communication with the user's computing device and the operator's computing device, where the user's computing device is configured to emulated an environment based on data received from the at least one sensor, and where the operator's computing device is configured to carry out at least one command from the user's computing device in accordance with a real-time event

### FIELD OF THE INVENTION

The present invention relates to enhanced reality systems. More precisely, the present invention relates to systems and methods of enhanced user interaction platform.

### BACKGROUND OF THE INVENTION

People do not want to be limited in their lives and we can see this in different ways in recent years alongside the advanced technology that able these changes to take places such as the freedom to choose and create a new finance instrument (cryptocurrency), selling your products online without a store, or rent your apartment instead of a hotel or be a taxi driver from your private car all of these and any more indicate on a change of the world as a consumer market that becomes more and more accessible to anyone.

One of these life limitations is the commitment to borders. Not everyone can visit wherever they want, and the reasons are different, it can be because of a political situation, entry visa run out, no money or just the race of life can't let them.

Various events can be lacking in the desired number of participants, for instance games, sporting event, etc. Many people attend different events as the audience but do not participate actively.

Thus, even if some event is “full” of people, some activities may be still empty or not completely full.

It would therefore be advantageous to allow people that are physically distant (e.g., in a foreign country) to actively participate in various events.

### SUMMARY OF THE INVENTION

According to some embodiments, systems and methods are provided for enhanced user experience by merging the virtual world and the real world through via data communication in order to enable the combination of realities.

The system and/or method may include a platform to communicate an event to an external party using a virtual reality (VR) or extended reality (XR) device, such that the user experiences the event at their current location (e.g., using dedicates sensors and/or display). Extended reality (XR) is a term inclusive to immersive learning technologies virtual reality (VR), augmented reality (AR), and mixed reality (MR).

The user experience may include the user performing a virtual task, with a corresponding task carried out in the real-world event.

In some embodiments, the user experience may be of a secure, scalable, reliable, environment with a flexible and/or smooth user and operator experience.

### BRIEF DESCRIPTION OF THE DRAWINGS

The subject matter regarded as the invention is particularly pointed out and distinctly claimed in the concluding portion of the specification.

The invention, however, both as to organization and method of operation, together with objects, features and advantages thereof, may best be understood by reference to the following detailed description when read with the accompanied drawings.

Embodiments of the invention are illustrated by way of example and not limitation in the figures of the accompanying drawings, in which like reference numerals indicate corresponding, analogous or similar elements, and in which:

FIG. 1 shows a block diagram of an exemplary computing device, according to some embodiments of the invention;

FIG. 2 shows an emulated user interaction system, according to some embodiments of the invention.

It will be appreciated that for simplicity and clarity of illustration, elements shown in the figures have not necessarily been drawn to scale.

For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details.

In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence.

Additionally, some of the described method embodiments or elements thereof may occur or be performed simultaneously, at the same point in time, or concurrently.

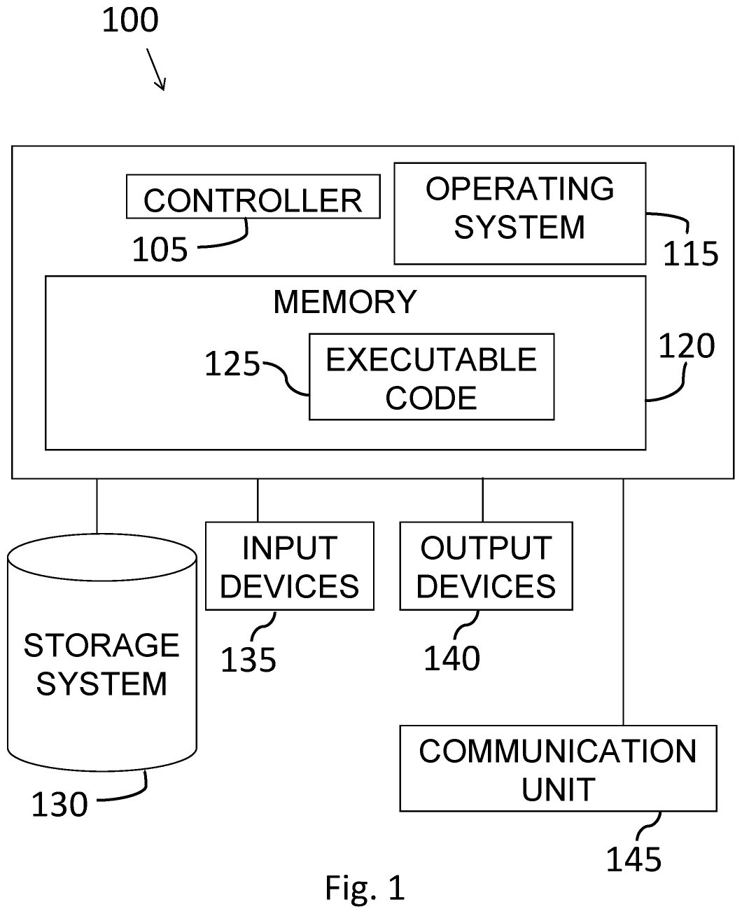

Reference is made to FIG. 1, which is a schematic block diagram of an example computing device, according to some embodiments of the invention.

Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet.

Controller 105 may be configured to execute program code to perform operations described herein.

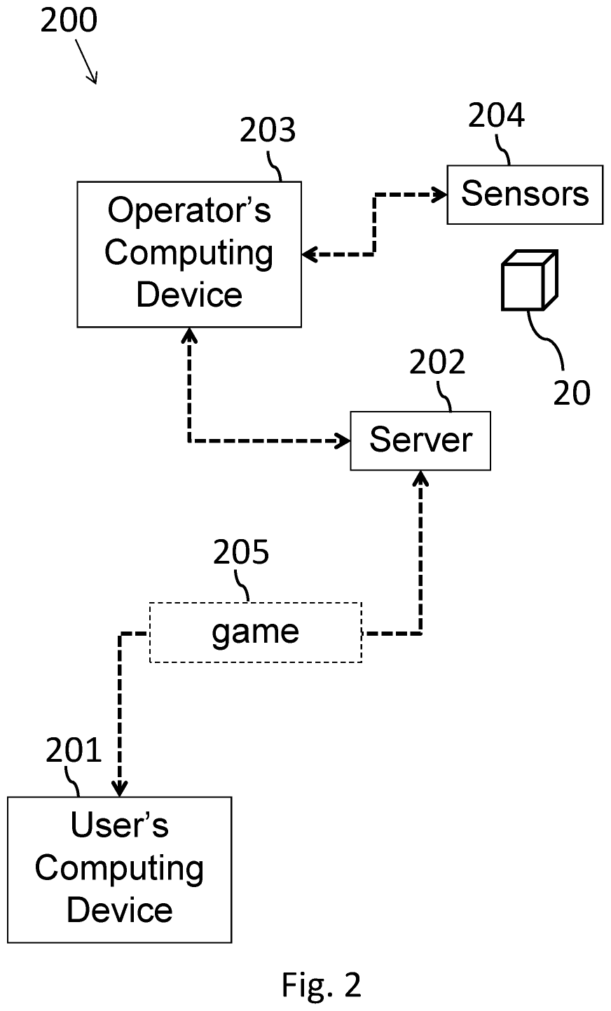

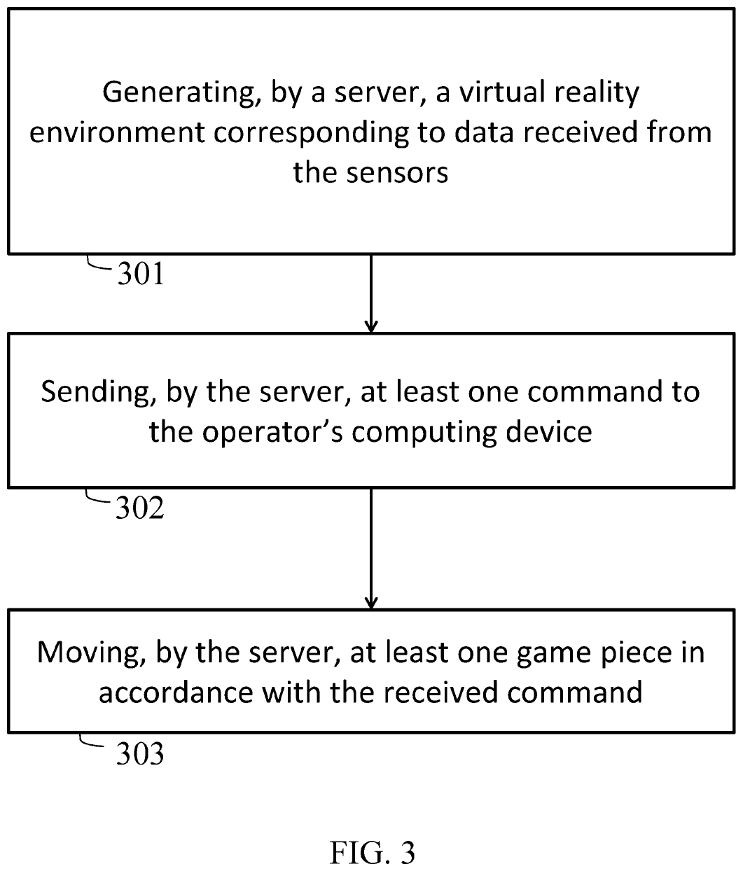

The system described herein may include one or more computing device(s) 100, for example, to act as the various devices or the components shown in FIG. 2. For example, system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units.

Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115.

For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted.

For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100.

Output devices 140 may include one or more displays or monitors and/or any other suitable output devices. Any suitable number of output devices 140 may be operatively connected to computing device 100.

Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

For example, an article may include a storage medium such as memory 120, computer-executable instructions such as executable code 125 and a controller such as controller 105.

Such a non-transitory computer readable medium may be for example a memory, a disk drive, or a USB flash memory, encoding, including or storing instructions, e.g., computer-executable instructions, which when executed by a processor or controller, carry out methods disclosed herein.

The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components.

In some embodiments, a system may include or may be, for example, a personal computer, a desktop computer, a laptop computer, a workstation, a server computer, a network device, or any other suitable computing device.

For example, a system as described herein may include one or more facility computing device 100 and one or more remote server computers in active communication with one or more facility computing device 100 such as computing device 100, and in active communication with one or more portable or mobile devices such as smartphones, tablets and the like.

In some embodiments, a combination of virtual reality and real world may be provided. For example, experience immersive reality where the players (or users) participate in a real evet (e.g., a card game, roulette, sports, gaming machines, and the like). Thus, it may be possible for simultaneous enhanced experience from the user side, as well as in the actual event where the user participates from a distance.

For example, a user joining a board game with a virtual reality headset, may experience the game on a dedicated display, while other players at the actual event may experience a corresponding action that is initiated by the distant user (e.g., movement of game pieces or flipping of cards).

In some embodiments, the virtual environment displayed to the user may include the geometry and/or visualization of the environment at the real world event.

In some embodiments, the combination of virtual reality and real world may allow the user to socially engage and interact with other participants at the event (e.g., engage with virtual and/or real participants using an avatar), for instance similar to online chatting using virtual reality. Once the user chooses to participate in an event, or game, the experience or engagement may be different and focused on the user.

For example, the user may experience and explore a comprehensive environment that simulates the real-world event (e.g., a music concert).

Reference is now made to FIG. 2, which shows a block diagram of an emulated user interaction system 200, in accordance with some embodiments.

In some embodiments, the direction of arrows may indicate the direction of information flow. Hardware components are indicated by a solid line, while software components are indicated by a dashed line.

The emulated user interaction system 200 may include a user's computing device 201 (e.g., such as controller 105, shown in FIG. 1) and a server 202, that are in communication (e.g., via the Internet).

The user's computing device 201 may include a user interface module, for instance including a display and/or a virtual reality headset, in order to experience an event.

The system 200 may further include an operator's computing device 203 (e.g., such as controller 105, shown in FIG. 1), in communication with the server 202.

The operator's computing device 203 may be used by an operator of the event and send event information to the user's computing device 201.

The operator's computing device 203 may also receive commands (e.g., in-game commands) and queries from the user's computing device 201, as further described hereinafter.

In some embodiments, the server 202 may facilitate the communication between the user's computing device 201 and the operator's computing device 203, as well as provide dedicated algorithms and/or software for data translation between protocols that may be required for the combination of the virtual reality and the real-world reality.

The hybrid or combination of the real world and virtual world must be synchronized and work in perfect synergy to provide for both sides the feel of a seamless one-piece product.

According to some embodiments, the system 200 may include at least one sensor (e.g., a camera) to capture an object or subject 20 at the event or game 205.

For example, the system 200 may include Internet of Things (IoT) sensors 204 employing at least one of: objects recognition and/or cameras.

In some embodiments, machine learning algorithms may be employed to differentiate virtually and real objects including human behavior especially when it mixed with virtually.

In order to achieve the user experience where the realities are combined, gives the player the feeling he actually seats at the table and located in the event.

In some embodiments, accessories such as a body tracker and/or some fittable wearable device may be employed as an object to mirror it virtually to the real world.

As the user seat sat the table, they also see a virtual menu, toolbar, or a different feature that helps him to bet or to operate, it could be a hand and body trucking with the headset sensors or through the controllers or with a virtual button on the screen of the real table. For example, the at least one sensor 204 may include an Optical Character Recognition (OCR) for board games.

For example, the user may see a green light over a particular game indicating a vacant spot. The user may tap the light or the spot, at this time the real dealer or manager get a notification in his computer or managing device or in the event.

The participation is confirmed, and the user may be seen on screen as well as be heard at the event, (e.g., via a hologram).

Every movement that the user makes in virtual reality accessories—the server may translate to a real move. For example, the user grabs the chips off the table, raise his amount or pull the slot machine stick, while in the real table, it may show the dealer that this player made an action that requires moving on the table.

In another example, the user joins a chess convention where multiple games 205 are carried out simultaneously. Upon selecting to join a chess game where only one other participant has joined, the user may control movement of physical chess pieces on the board. For instance, by moving the virtual queen at the user's computing device 201, a corresponding physical queen piece may be moved across the board (e.g., using magnetic means to move chess pieces on the board).

In some embodiments, everything that the real player can have the player can have too in other formation. If we think of the average time waiters need to bring a beer to a game table is not far from food or grocery delivery service in the big cities the collaboration could be with some kind of delivery companies such as Uber Eats during the game.

According to some embodiments, at least one game or activity at the event may have a corresponding digital version. For instance, a user selects to play a slot machine at a casino may be directed to a digital version of the game in the virtual reality, while the physical machine may be indicated as “taken” and substantially blocked to other users (both virtual and real) while this user is playing.

In another example, a user selects a poker game and be directed to a digital version, while the user's actions in the game are broadcasted (e.g., with a dedicated projector) to the physical game.

In yet another example, a home user may be able to set the game and see the table in his “living room” or any different property with the combined reality where the virtual objects may be a part of his real world.

A digital layer may be added on the physical objects that are present in the casino floor in a way that the physical real object remains and seen as real, and all the other environments can be changed in a virtual way and design and create a mixed reality.

In yet another example, the real world may be integrated or combined with virtual layers and/or into virtual graphics and realities or go into supermarket or restaurant see the grocery and food talk to the manager or go into store feel the clothes and bags.

According to some embodiments, the system 200 may automatically map all connected computing devices.

According to some embodiments, the server may include dedicated logic to operate the event. The server may provide a video feed via the sensors 204 (e.g., a camera) to be broadcasted to the user.

In some embodiments, the system 200 may include an authorization module to authenticate and verify the identity of users (e.g., using two factor authentication). After the user's identity has been verified, the system may requests a corresponding one-time token for future authentication.

According to some embodiments, the system 200 may include a hybrid Computer Generated Imagery (CGI) virtual and/or real video environment, that may be powered with a dedicated game engine. The unique experience this solution provides is the ability for virtual users to participate in a live game (e.g., at an actual event in tandem with physical players). Both physical and virtual players see the same game table via the same live stream/physical location and both physical and virtual players can see all bets simultaneously.

In some embodiments, the system 200 may include additional sensors that are coupled to the user's computing device 201 and intended to capture the user for enhanced experience at the event (e.g., viewing a hologram of the user at a dedicated seat).

Reference is now made to FIG. 3, which shows a flow chart of a method of emulated user interaction, according to some embodiments.

In Step 301, a virtual reality environment corresponding to data received from the sensors may be generated (e.g., by the server).

In Step 302, at least one command may be sent to the operator's computing device (e.g., by the server).

In Step 303, at least one game piece may be moved (e.g., by the server) in accordance with the received command.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An emulated user interaction system, comprising:
a user's computing device;
an operator's computing device, coupled to at least one sensor; and
a server, in communication with the user's computing device and the operator's computing device,
wherein the user's computing device is configured to emulate an environment based on data received from the at least one sensor; and
wherein the operator's computing device is configured to carry out at least one command from the user's computing device in accordance with a real-time event.

2. The system of claim 1, wherein the user's computing device comprises an extended reality device.

3. The system of claim 1, wherein the at least one command comprises a command to move a physical object by the operator's computing device.

4. A method of emulated user interaction, the method comprising:
generating, by a server, a virtual reality environment corresponding to data received from the sensors;
sending, by the server, at least one command to an operator's computing device; and
moving, by the server, at least one game piece in accordance with the received command,
wherein the user's computing device is configured to emulate an environment based on data received from the at least one sensor.
